(19) United States
(12) Patent Application Publication
(10) Pub. No.: US 2020/0211139 A1
(43) Pub. Date: Jul. 2, 2020

(54) EXTRA DUTY SCHEDULING SYSTEM

(71) Applicants: Rich Milliman, Weston, CT (US); Adam Bryan, Bristol, CT (US)

(72) Inventors: Rich Milliman, Weston, CT (US); Adam Bryan, Bristol, CT (US)

(21) Appl. No.: 16/233,188

(22) Filed: Dec. 27, 2018

(51) Int. Cl. G06Q 50/26; G06Q 10/06; G06Q 10/10

(52) U.S. Cl. CPC G06Q 50/26; G06Q 10/1095; G06Q 10/063116

(57) ABSTRACT

A scheduling system for scheduling extra duty details comprising: a processor in communication with an internet; the processor configured to identify a customer who contacts the scheduling system and determine what the proper law enforcement department is available to the customer, and route the customer to the proper customer representative; the processor is further configured to display to the proper customer representative's communication terminal the proper law enforcement department rules, rates and any other pertinent information; the processor is further configured to receive data about the extra duty detail request such as date, time, and location from the customer or customer representative; the processor is further configured to indicate whether law enforcement department approval of the extra duty detail request; the processor is further configured to process the extra duty detail requests with the appropriate parameters; and the processor is further configured to process the extra duty detail pay and invoice the customer. A non-transitory computer-readable storage medium storing computer-readable instructions thereon, the instructions, when executed by one or more processors of a service scheduling system, cause the service scheduling system to perform a method comprising: identifying a customer who contacts the scheduling system; determining what the proper law enforcement department is available to the customer; routing the customer to the proper customer representative; displaying at the proper customer representative's communication terminal the proper law enforcement department rules, rates and any other pertinent information; receiving data about the extra duty detail request such as date, time, and location from the customer or customer representative; indicating whether law enforcement department approval of the extra duty detail request; processing the extra duty detail requests with the appropriate parameters; and processing the extra duty detail pay; and invoicing the customer.

### TECHNICAL FIELD

The present invention relates in general to system of scheduling extra duty details for law enforcement personnel, and in particular to a system that consolidates and automates the administration of scheduling extra duty details for law enforcement personnel.

### BACKGROUND

Law enforcement personnel often work “extra” duty details for entities such as private companies, churches, etc. Extra duty details may also be called “off duty details” or “secondary employment”. Law enforcement personnel are generally paid by the private companies when they do this. The industry norm for extra duty program administration is for the law enforcement department to administer their own program. Typically, there are one or more officers in the law enforcement department which operate the program. There may also be at least one person in the city finance department who handles invoicing and collections. Some law enforcement departments hire one or more civilians to run these programs. For example, the hypothetical Capital City Police Department may have a designated person or persons administer the scheduling and administration of extra duty jobs for Capital City Police Department law enforcement personnel. Some law enforcement agencies use little or no technology to administer their program. Some law enforcement departments use third party software. All of the extra duty software currently available is geared for use by the law enforcement department itself. The known extra duty software is built “within law enforcement department”—in other words, if a user is inputting a new extra duty detail he would have to “logon” using his credentials and, at that point, would be “within” a single department. That user would only see one law enforcement department in their software setup. The logging in and out of departments comes into play for organizations that administering more than one law enforcement department. Organizations which administer extra duty programs for more than one agency often have to log in and log out to handle multiple law enforcement department extra duty details. If a user from such an organization was logged into a particular department, but then wanted to check the time of a detail for a different law enforcement department, he would have to exit out of the first law enforcement department's login credentials, and logon to the other law enforcement department's credentials and go from there.

Different law enforcement departments award their details in different ways. While there are several software packages which enable an law enforcement department to award their details in these different ways, I don't know of any in which one can identify the law enforcement department and then the software knows to apply that law enforcement department's rules to the award process. For example, Capital City might award their extra duty details using a rotation list in which all extra duty details called in today are put into their software as they are called in, officers see the extra duty details and can request which ones they are interested in, at 6 pm today, all the details are awarded via a rotation list. Standard scheduling software would require an individual to enter each extra duty detail call into Capital City today as visible by officers until 6 pm and then awarded via a rotation list. Likewise, that individual would need to specify officers should receive emails/texts informing them of that detail being available.

Thus there is a need for an extra duty scheduling system that overcomes the above listed and other disadvantages.

### SUMMARY OF THE INVENTION

The disclosed invention relates to a scheduling system for scheduling extra duty details comprising: a processor in communication with an internet; the processor configured to identify a customer who contacts the scheduling system and determine what the proper law enforcement department is available to the customer, and route the customer to the proper customer representative; the processor is further configured to display to the proper customer representative's communication terminal the proper law enforcement department rules, rates and any other pertinent information; the processor is further configured to receive data about the extra duty detail request such as date, time, and location from the customer or customer representative; the processor is further configured to indicate whether law enforcement department approval of the extra duty detail request; the processor is further configured to process the extra duty detail requests with the appropriate parameters; and the processor is further configured to process the extra duty detail pay and invoice the customer.

The invention also relates to a non-transitory computer-readable storage medium storing computer-readable instructions thereon, the instructions, when executed by one or more processors of a service scheduling system, cause the service scheduling system to perform a method comprising: identifying a customer who contacts the scheduling system; determining what the proper law enforcement department is available to the customer; routing the customer to the proper customer representative; displaying at the proper customer representative's communication terminal the proper law enforcement department rules, rates and any other pertinent information; receiving data about the extra duty detail request such as date, time, and location from the customer or customer representative; indicating whether law enforcement department approval of the extra duty detail request; processing the extra duty detail requests with the appropriate parameters; and processing the extra duty detail pay; and invoicing the customer.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a flowchart showing one embodiment of the invention;

FIG. 2 is a flowchart showing another embodiment of the invention;

FIG. 3 is a continuation of the flowchart from FIG. 2;

FIG. 4 is a screenshot of the scheduling system; and

FIG. 5 is a schematic diagram of the scheduling system.

### DETAILED DESCRIPTION OF THE INVENTION

The software that embodies the disclosed scheduling system is designed to work across one or more law enforcement departments. This will enable very significant manpower efficiencies as the time it takes to “jump” across law enforcement departments will be knocked down to hardly anything.

Another advantage in the scheduling system is that it automates much of the law enforcement department rules into the scheduling system itself, so the amount of information which needs to be entered with each new extra duty detail is significantly decreased. Each time an extra duty detail is entered the “detail” information itself needs to be entered (e.g., start time, end time, number of officers, location, if a cruiser is requested, etc.). However, there is also information specific to the law enforcement department's rules which need to be entered with each new extra duty detail. For example, how is this extra duty detail going to be awarded? Will it be assigned on a first-come-first-served basis, or using some kind of rotation list or point system and, if so, how long do officers have to request the extra duty detail before its assigned and when can the officers actually see the extra duty detail in the scheduling system, etc. All of the law enforcement department rule information can now be entered once upon initial set-up and the software will then correctly assign and communicate each law enforcement department's details according to those rules and without the need for those rules to be re-entered into the software with each new detail.

The software that embodies in the disclosed scheduling system may have all the logic pre-defined at the law enforcement department level, so when an extra duty detail is called in for Capital City, the scheduling system will email/text all appropriate officers, make the extra duty detail visible to them and award it at 6 pm via the rotation list, for example. The user just enters the detail start/end time, number of officers, location and the software does the rest.

Moreover, the software will be able to jump from one law enforcement department to another law enforcement department. So, when a call comes from a customer into one of the customer representatives, they will see, on one of the screens, which law enforcement department the call is for as the scheduling system identifies the unique phone numbers for each law enforcement department programmed into the scheduling system. On the landing screen of the scheduling software the customer representative can pick the correct law enforcement department name from a dropdown box (Capital City in the example above), and then fill in the detail information on the same page, click enter, and the software does the rest. If the next call comes in from Gotham City, the customer representative doesn't change screens or have to log out of Capital City and into Gotham City—he or she just selects Gotham City from the drop down and is off and running.

The ability to jump from law enforcement department to law enforcement department on the same landing screen is advantageous and time saving for the customer representative. Also, the ability to enter the basic extra duty detail information and have the software post, communicate and schedule the detail at the right times and under the right set of law enforcement department-specific rules, is also unique.

Moreover, the entire workflow of the disclosed scheduling system will be unique within the industry. The scheduling system will identify the unique phone number for each law enforcement department that is associated with the scheduling system. The phone number may be identified via the call routing module of the software. The customer representative may then select the name of the law enforcement department from a landing page drop down box in the scheduling software. Using call routing logic in this industry is unique and the drop down box to begin the handling of an extra duty detail is also unique in the industry. When a call comes in, the scheduling system call routing module automatically routes the call to the customer representative (different customer representatives may manage different law enforcement departments). Before the customer representative answers the call, the scheduling system call routing module shows that law enforcement department's rules and rates on the communication terminal/computer screen. If a customer representative is handling 10 law enforcement departments, call 1 might be from Capital City and call 2 from Gotham City. It can be confusing to keep track of all the law enforcement department rates and rules so having that information auto-populate on the screen using the scheduling system and unique phone numbers of each law enforcement department solves that problem. In addition, the scheduling may be able to identify the proper law enforcement department for each customer via email, or if the customer logs in to the scheduling system. A customer can reach an organization that administers extra duty programs via a telephone call or online. The online methods may include: (1) the customer can just email the account rep if they've worked together previously on some other detail. (2) The customer could be assigned a portal in the scheduling system. In the customer portal they can see what previous extra duty details they have had, what extra duty details they may have coming up, which law enforcement persons worked which details, etc., and they can also submit an email which is automatically send to the correct customer representative. For example, a customer of Capital City law enforcement department, if they are in their portal and submit an email to ask a question or request a detail, that email gets routed right to the Capital City law enforcement department team working for the organization that administers extra duty programs. (3) Click on a link the organization provide them which takes them to an online detail request form. This may be a “hidden” part of our website. That detail form asks questions of the customer (billing info, number of officers, start time, end time); it enables them to enter a credit card, etc. The resulting form is emailed directly to the correct customer representative or customer team for processing.

If the customer is calling to request officers, the coordinator can, on one screen, as explained above, enter the pertinent information and be done. The scheduling system posts, communicates and awards the detail within the correct law enforcement department and according to that law enforcement department's rules.

The method (procedure flow) using unique phone numbers, call routing software linked to law enforcement department information visible to the coordinator, and the software capabilities of x-law enforcement department data entry and within-law enforcement department automated detail communication, posting, assignment is unique.

The disclosed invention is an outsourced solution to the administration of these programs. The scheduling system uses technology to make more efficient the whole extra duty detail scheduling process, and costs the law enforcement department nothing, eliminates all of the financial risk and some of the legal risk for the municipality. The scheduling system eliminates the administrative burden on the department and transfers the cost of operating the program from the taxpayer base to whichever customers (companies) are hiring the officers.

The scheduling system is more efficient because similar activities which occur within any given department—for example, engaging with customers on the phone or email, taking orders, communicating the detail opportunities to officers, scheduling officers, paying the officers and invoicing the customers can be done by a third party, rather than by using dedicated personnel within the law enforcement department. The scheduling system handles these activities across many law enforcement departments and are doing it much more efficiently. In addition, the scheduling system operates across law enforcement departments rather than just within department, thus enabling to scheduling system to handle the administration of several department programs in a much more efficient manner.

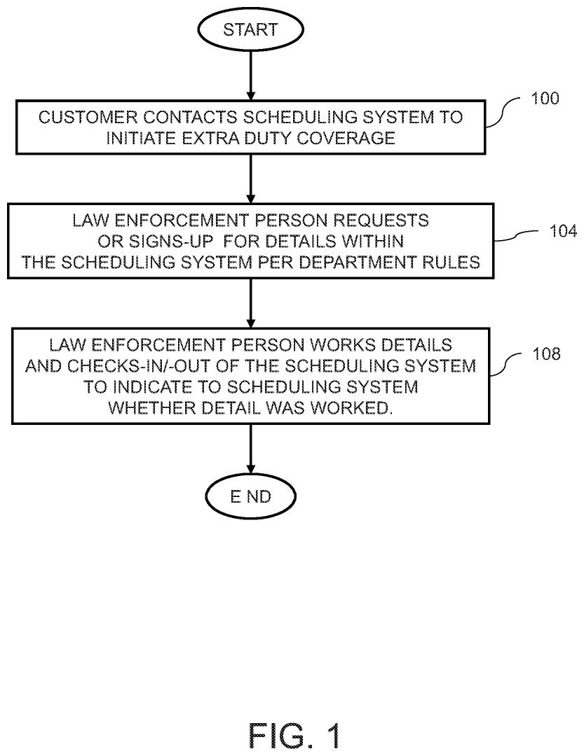

FIG. 1 is a flowchart showing one embodiment of the invention. At act 100, the customer contacts the scheduling system to initiate extra duty coverage. The contact may be through a customer portal. The customer is generally an entity, facility, or organization that desires off-duty law enforcement personnel to provide security. The customer can contact the scheduling system through their own telephone number, via a dedicated telephone number, dedicated email, or through an interne website. The scheduling system can identify the customer by the law enforcement department it will use. The law enforcement department means the particular law enforcement agency, e.g. Capital City Policy Department, Bexar County Sheriff's Department, etc. At act 104, a law enforcement person requests or signs-up for extra-duty details within the scheduling system as per his department rules. These law enforcement department rules will be programmed into the scheduling system. At act 108, the law enforcement person works the extra-duty detail and checks-in/-out in the scheduling system to indicate to scheduling system whether detail was worked.

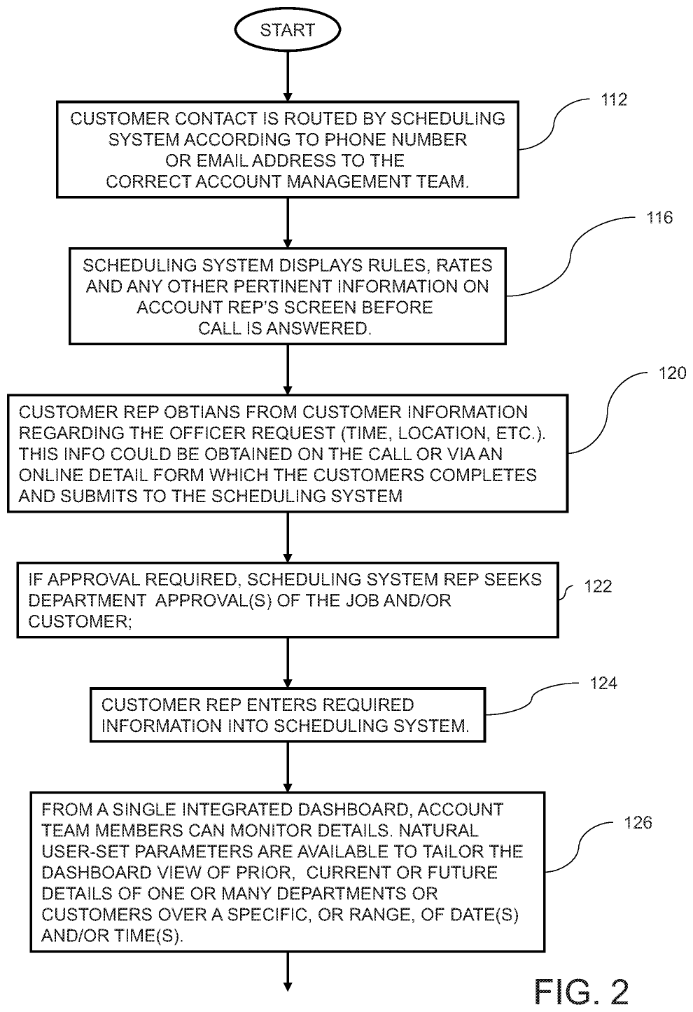

FIG. 2 is another embodiment of the invention. At act 112 customer contact is routed by the scheduling system to the correct account management team or customer representative. Phone calls may be routed by routing modules in the scheduling system, emails may go to the correct account team email and requests from the portal get to the right account team via the scheduling system. This may be done because the scheduling system recognizes the phone number of the customer, or email of the customer or the customer may call into a dedicated phone number, or email a dedicated email address. At act 116, the scheduling system displays rules, rates and any other pertinent information on a customer representative's screen before customer directly communicates with customer representative. The scheduling system will recognize the phone number, email address, dedicated phone number, or dedicated email address used by customer. This makes it easier, more productive, and streamlined for the customer representative to handle the customer's request, when all the details of the customer and the local law enforcement department rules, requirements, and other details are provided on a screen for the customer representative. At act 120 the customer representative obtains information regarding the extra duty job officer request (time, location, etc.) from the customer either via a telephone call from customer, or via an online detail form which the customers completes and submits to the scheduling system. At act 122, if approval required, the customer representative seeks law enforcement department approval(s) of the job and/or customer. Law enforcement department approval may be necessary if a request is unusual. The organization may reach out to a single point of contact within the law enforcement department and obtain approval or have the request denied. For example, if a charity putting on a 5 k race asks for one officer for that extra duty detail, the organization may request the course map be emailed to the organization share that with the our single point of contact within the law enforcement department to find out the number of officers the department would require. Only 2-3% of all extra duty details require this kind of approval. At act 124, the customer representative enters required information into scheduling system. This information may include: department, start time, end time, customer or detail type, cruiser request, number of officers. New information may be added by inputting department, date, time, customer, and location to a single page form that concurrently calculates and displays all other parameters of detail. Customer representatives are able to manually override the automatic processes setting to meet any unique requirement of a specific detail. Simple selections are available, from the scheduling system “dashboard”, to drill-down to the department or customer to view, edit, sort and filter past, current and future details. At act 126, the scheduling system can provide a dashboard view to allow for the monitoring of details. The dashboard can be tailored by natural user-set parameters so that current or future details of one or many law enforcement departments or customers over a specific, or range, of date(s) and/or time(s).

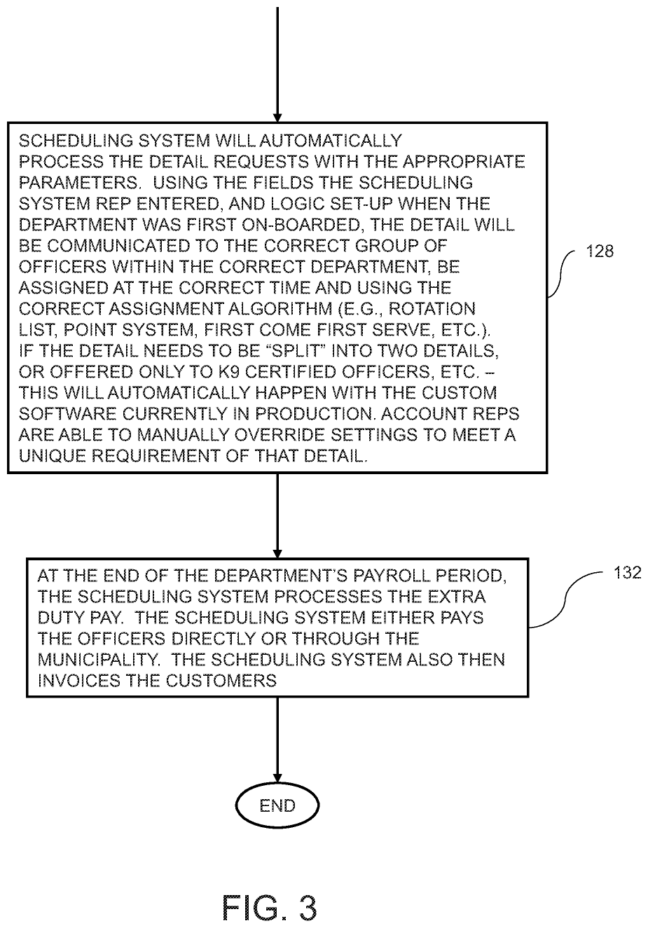

On FIG. 3, the flowchart from FIG. 2 continues. At act 128, the scheduling system will automatically process the detail requests with the appropriate parameters. Using the fields the customer representative entered, and logic set-up when the law enforcement department was first on-boarded, the extra duty detail will be communicated to the correct group of officers within the correct department, be assigned at the correct time and using the correct assignment algorithm (e.g., rotation list, point system, first come first serve, etc.). If the detail needs to be “split” into two details, or offered only to k9 certified officers, etc.—this will automatically happen with the scheduling system. Customer representatives are able to manually override settings to meet unique requirements of particular extra duty details. At act 132, at the end of the law enforcement department's payroll period, the scheduling system processes the extra duty pay. The scheduling system either pays the officers directly or through the municipality, depending on how the scheduling system was programmed. The scheduling system may also then invoices the customers.

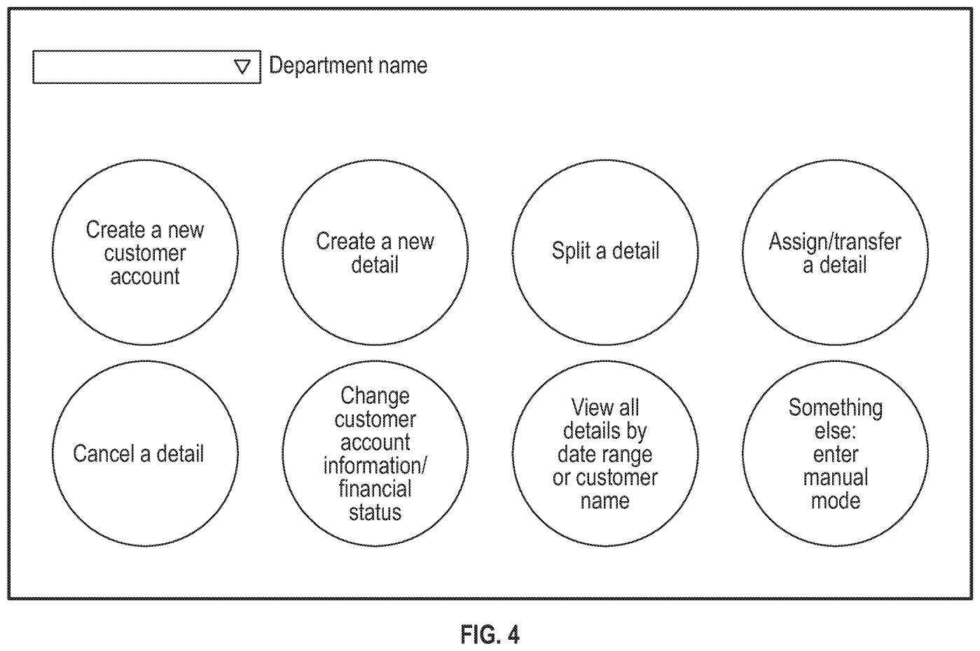

FIG. 4 is a drawing of a proposed screen shot from the scheduling system. FIG. 4 shows a drop down menu for “department name” where a particular pre-programmed law enforcement department may be selected. Eight buttons are shown where a user may select a particular menu item, such as: “create a new customer account”; “create a new detail” (where a new detail may mean a new extra-duty assignment); “split a detail” (where an extra duty detail may be split into 2 or more extra duty details); “assign/transfer a detail” (where an extra-duty detail is assigned or transferred to a particular law enforcement person; “cancel a detail”; “change customer account information/financial status”; “view all details by date range or customer name”; “something else, enter manual mode” (where the user can program a special menu item). This multi-department user interface is an important advantage of the disclosed scheduling system.

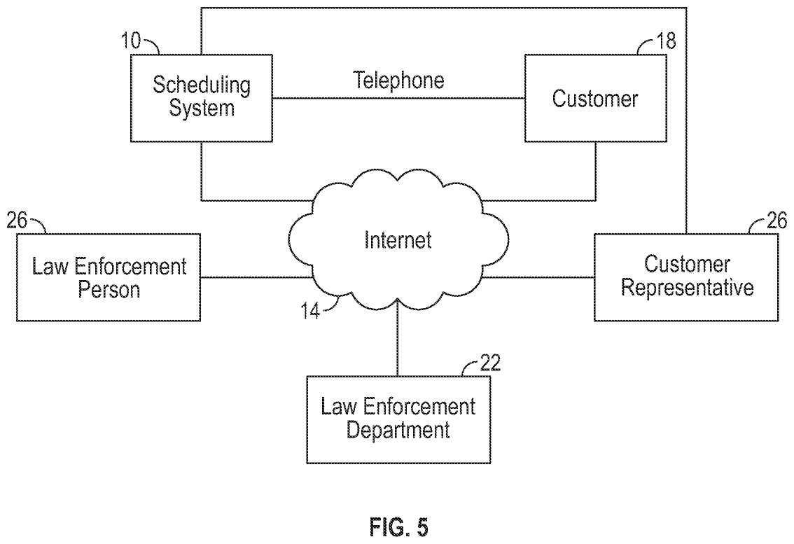

FIG. 5 is a schematic showing who the scheduling system 10 may be in communication with an internet 14. Customers 18 may contact the scheduling system 10 through the internet or via telephone. Law enforcement departments 22 may contact the scheduling system via the internet. Individual law enforcement persons 26 may contact the scheduling system via the internet too. A customer representative 26 is in communication with the scheduling system via the internet or directly.

The scheduling system may comprise software which comprises computer-readable instructions. The computer-readable instructions may be executed by one or more processors of the scheduling system. In some embodiments, the software is implemented, executed, launched and used in a computing device. Examples of such a computing device include but are not limited to a desk top computer, tablet, a laptop computer, a personal digital assistant (PDA), a BLACKBERRY device developed by Research in Motion (RIM) of Waterloo, Ontario, Canada, an IPHONE device developed by Apple Computers Inc. of Cupertino, Calif., smart watch, and any other smartphone and cell phone as apparent to one skilled in the art.

Throughout this patent application, numerous references may be made regarding servers, services, engines, modules, interfaces, portals, platforms, or other systems formed from computing devices. It should be appreciated that the use of such terms are deemed to represent one or more computing devices having at least one processor configured to or programmed to execute software instructions stored on a computer readable tangible, non-transitory medium. For example, server can include one or more computers operating as a web server, database server, or other type of computer server in a manner to fulfill described roles, responsibilities, or functions. Within the context of this document, the disclosed smart phones, tablets, or hand held computers are also deemed to comprise computing devices having a processor and a non-transitory memory storing instructions executable by the processor that cause the device to control, manage, or otherwise manipulate the features of the disclosed apparatuses, systems and methods.

The disclosed scheduling system has many advantages. The scheduling system allows a user to quickly jump from one law enforcement department to another without having to login and logout multiple times. The scheduling system populates a communication terminal so that when a customer representative is discussing an extra duty detail with a customer, the local rules and requirements of the relevant law enforcement department is visible to the customer service representative. The scheduling system allows more than one law enforcement department screen to be opened at once. The disclosed scheduling system enables a single coordinator to process incoming details from multiple law enforcement departments without having to be intimately familiar with all the specific rules and regulations of each of those law enforcement departments. The scheduling system is programed with the rules and regulations and practices of each law enforcement department, and that information does not need to be input every time a new detail comes in. Without this, a coordinator can really only work on a few law enforcement departments at one time, because it would be very difficult to keep track of the rules, regulations and practices of more than a few law enforcement departments at a time. With this scheduling system a coordinator can work on an unlimited number of law enforcement departments.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A scheduling system for scheduling extra duty details comprising:
a processor in communication with an internet;
the processor configured to identify a customer who contacts the scheduling system and determine what the proper law enforcement department is available to the customer, and route the customer to the proper customer representative;
the processor is further configured to display to the proper customer representative's communication terminal the proper law enforcement department rules, rates and any other pertinent information;
the processor is further configured to receive data about the extra duty detail request such as date, time, and location from the customer or customer representative;
the processor is further configured to indicate whether law enforcement department approval of the extra duty detail request;
the processor is further configured to process the extra duty detail requests with the appropriate parameters.

2. The scheduling system of claim 1, wherein the processor is further configured to receive data, such as department, start time, end time, customer or detail type, cruiser request, number of officers, entered into the scheduling system by the customer representative

3. The scheduling system of claim 1, wherein the processor is further configured to allow data to be entered into the scheduling system by inputting department, date, time, customer, and location to a single page form that concurrently calculates and displays all other parameters of detail.

4. The scheduling system of claim 1, wherein the processor is further configured to allow customer representatives to override the automatic processes setting to meet any unique requirement of a specific detail.

5. The scheduling system of claim 1, wherein the processor is further configured to provide a dashboard view to a customer representative's communication terminal to allow for the monitoring of the extra duty details.

6. The scheduling system of claim 5, wherein the dashboard can be tailored by natural user-set parameters so that current or future details of one or many law enforcement departments or customers over a specific, or range, of date(s) and/or time(s).

7. The scheduling system of claim 1, wherein the processor is further configured to accept data entered by the customer representative and logic selected by the customer representative, and the processor is further configured to communicate extra duty detail information to one or more law enforcement persons within the correct law enforcement department.

8. The scheduling system of claim 7, wherein the processor is further configured to assign one or more law enforcement persons to the extra duty detail at the correct time and using the correct assignment algorithm.

9. The scheduling system of claim 8, wherein the correct assignment algorithm is selected from the group consisting of rotation list, point system, first come first serve.

10. The scheduling system of claim 9, wherein the processor is configured to split the extra duty detail into two extra duty details when necessary.

11. The scheduling system of claim 9, wherein the processor is configured to offer the extra duty detail only to K9 law enforcement personnel.

12. The scheduling system of claim 1, wherein the processor is further configured to process the extra duty detail pay and invoice the customer.

12. A non-transitory computer-readable storage medium storing computer-readable instructions thereon, the instructions, when executed by one or more processors of a service scheduling system, cause the service scheduling system to perform a method comprising:
identifying a customer who contacts the scheduling system;
determining what the proper law enforcement department is available to the customer;
routing the customer to the proper customer representative;
displaying at the proper customer representative's communication terminal the proper law enforcement department rules, rates and any other pertinent information;
receiving data about the extra duty detail request such as date, time, and location from the customer or customer representative;
indicating whether law enforcement department approval of the extra duty detail request;
processing the extra duty detail requests with the appropriate parameters; and
processing the extra duty detail pay; and
invoicing the customer.

13. The method of claim 12, the method further comprising:
receiving data, such as department, start time, end time, customer or detail type, cruiser request, number of officers, entered into the scheduling system by the customer representative

14. The method of claim 12, the method further comprising:
allowing data to be entered into the scheduling system by inputting department, date, time, customer, and location to a single page form that concurrently calculates and displays all other parameters of detail.

15. The method of claim 12, the method further comprising:
allowing customer representatives to override the automatic processes setting to meet any unique requirement of a specific detail.

16. The method of claim 12, the method further comprising:
providing a dashboard view to a customer representative's communication terminal to allow for the monitoring of the extra duty details.

17. The method of claim 16, the method further comprising:
tailoring the dashboard by natural user-set parameters so that current or future details of one or many law enforcement departments or customers over a specific, or range, of date(s) and/or time(s).

18. The method of claim 12, the method further comprising:
accepting data entered by the customer representative and logic selected by the customer representative;
communicating extra duty detail information to one or more law enforcement persons within the correct law enforcement department.

19. The method of claim 18, the method further comprising:
assigning one or more law enforcement persons to the extra duty detail at the correct time and using the correct assignment algorithm.

20. The method of claim 19, the method further comprising:
selecting the correct assignment algorithm from the group consisting of rotation list, point system, first come first serve.

21. The method of claim 20, the method further comprising:
splitting the extra duty detail into two extra duty details when necessary.

22. The method of claim 20, the method further comprising:
offering the extra duty detail only to K9 law enforcement personnel.
